(19) United States
(12) Patent Application Publication
(10) Pub. No.: US 2024/0265250 A1
(43) Pub. Date: Aug. 8, 2024

(54) SYSTEM AND METHOD FOR SPATIAL SALIENCY EXPLANATION FOR TIME SERIES MODELS

(71) Applicant: Microsoft Technology Licensing, LLC, Redmond, WA (US)

(72) Inventors: Pranay Kumar LOHIA, Bengaluru (IN); Badri Narayana PATRO, Bengaluru (IN); Naveen PANWAR, Bengaluru (IN)

(21) Appl. No.: 18/163,711

(22) Filed: Feb. 2, 2023

(51) Int. Cl. G06N 3/08

(52) U.S. Cl. CPC G06N 3/08

(57) ABSTRACT

Example aspects include techniques for spatial saliency explanation for Time Series machine learning models. These techniques may include identifying, based on a token-based importance method, a plurality of tokens of a predefined importance to a machine learning (ML) inference. In addition, the techniques may generating frequency distribution information based on the plurality of tokens of the predefined importance, and generating, based on the frequency distribution information, quantile information for the plurality of tokens of a predefined importance. Further, the techniques may include calculating spatial saliency information based on the frequency distribution information and quantile information, the spatial saliency information including a spatial saliency value for a quantile of the quantile information, and presenting the spatial saliency information via a graphical user interface.

### BACKGROUND

Machine learning (ML) has been integrated into a wide range of use cases and industries. For instance, ML models may be used to generate predictions within various software applications. For simple ML models, identifying factors that contribute to a prediction generated by an ML model can be straightforward. However, as ML model complexity has increased, identification of these contributing factors has become increasingly difficult. For example, Deep Neural Networks (DNNs) with thousands or even millions of parameters, are considered black boxes as the behavior of a ML model of a DNN cannot be comprehended. As a result, some system operators have begun to adopt explainability techniques for identifying the contributing aspects of an ML model to a prediction. However, many explainability methods fail to provide useful data for ML models used for time series prediction.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In some aspects, the techniques described herein relate to a method including: identifying, based on a token-based importance method, a plurality of tokens of a predefined importance to a machine learning (ML) inference; generating frequency distribution information based on the plurality of tokens of the predefined importance; generating, based on the frequency distribution information, quantile information for the plurality of tokens of a predefined importance; calculating spatial saliency information based on the frequency distribution information and quantile information, the spatial saliency information including a spatial saliency value for a quantile of the quantile information; and presenting the spatial saliency information via a graphical user interface.

In another aspect, a device may include a memory storing instructions, and at least one processor coupled with the memory and to execute the instructions to: identify, based on a token-based importance method, a plurality of tokens of a predefined importance to a machine learning (ML) inference; generate frequency distribution information based on the plurality of tokens of the predefined importance; generate, based on the frequency distribution information, quantile information for the plurality of tokens of a predefined importance; determine spatial saliency information based on the frequency distribution information and quantile information, the spatial saliency information including a spatial saliency value for a quantile of the quantile information; and present the spatial saliency information via a graphical user interface.

In another aspect, an example computer-readable medium (e.g., non-transitory computer-readable medium) storing instructions for performing the methods described herein and an example apparatus including means of performing operations of the methods described herein are also disclosed.

Additional advantages and novel features relating to implementations of the present disclosure will be set forth in part in the description that follows, and in part will become more apparent to those skilled in the art upon examination of the following or upon learning by practice thereof.

### BRIEF DESCRIPTION OF THE DRAWINGS

The Detailed Description is set forth with reference to the accompanying figures, in which the left-most digit of a reference number identifies the figure in which the reference number first appears. The use of the same reference numbers in the same or different figures indicates similar or identical items or features.

FIG. 1 illustrates an example architecture of a SSE system, in accordance with some aspects of the present disclosure.

FIG. 2 illustrates example spatial saliency information in a tabular representation, in accordance with some aspects of the present disclosure.

FIG. 3 illustrates example spatial saliency information in a graph representation, in accordance with some aspects of the present disclosure.

FIG. 4 is a flow diagram illustrating an example method for spatial saliency explanation for time series models, in accordance with some aspects of the present disclosure.

FIG. 5 is a block diagram illustrating an example of a hardware implementation for a computing device(s), in accordance with some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes techniques for spatial saliency explanation for time series models. Machine learning (ML) generally refers to the application of pattern recognition and/or statistical inference techniques by a computing system to perform specific tasks. Some machine learning systems build predictive models based on sample data and validate the predictive models using validation data. Further, upon receipt of inference data, the predictive model may be used to accurately predict unknown values of targets of the inference data set. Many predictive model systems operate as black box systems where the internal details of the predictive model systems are unknown and/or incomprehensible to the users of the systems. For example, a convolutional neural network may be configured to generate classification prediction, and users of the convolutional neural network will be unaware of how the convolutional neural network determined the classification prediction. Explainability techniques provide understanding as to how a predictive model generates particular predictive output. For example, explainability may be used to determine the contributing features of a classification prediction of a convolutional neural network.

However, conventional explainability techniques for time series forecasting and anomaly detection models fail to provide useful information. In particular, unlike some other explainability techniques where users benefit from the identification of one or more individual tokens within the inference data set, providing one or more isolated points within time series data fails to provide probative insight that may be used determine whether the prediction model and/or the output of the prediction model should be employed within a system. As such, many conventional explanation techniques are of limited utility in contexts employing time series forecasting and anomaly detection models.

Aspects of the present disclosure provide a novel and informative time series explainability technique for time series forecasting and anomaly detection models, e.g., black box time series forecasting and anomaly detection models. Instead of simply providing explanations including the importance of individual timestamps, the present disclosure focuses on the saliency (e.g., aggregated importance) of spatial groupings (e.g., quantiles) in generating time series explanation. Accordingly, the present techniques address limitations of convention explainability techniques, by providing informative explanation data for time series forecasting and anomaly detection models.

### Illustrative Environment

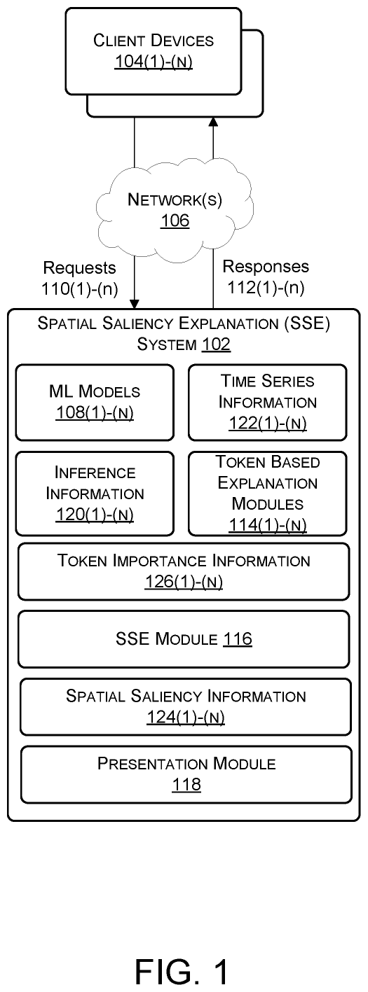

FIG. 1 is a diagram showing an example of a ML environment 100, in accordance with some aspects of the present disclosure.

As illustrated in FIG. 1, the ML environment 100 includes a spatial saliency explanation (SSE) system 102 for spatial saliency explanation for time series models. In some aspects, the SSE system 102 is a cloud computing platform that provides client devices 104 with distributed storage and access to software, services, files, and/or data via one or more network(s) 106, e.g., cellular networks, wireless networks, local area networks (LANs), wide area networks (WANs), personal area networks (PANs), the Internet, or any other type of network configured to communicate information between computing devices. Further, in some aspects, the client devices 104 include one or more applications configured to interface with the SSE system 102 or one or more ML models 108(1)-(n) of the SSE system 102. Further, the client devices 104 are associated with customers of the operator of the SSE system 102 or end-users that are subscribers to services and/or applications of the customers that are hosted on the SSE system 102 and provided by the customers to the end users via the SSE system 102. Some examples of an application include programs, software, web applications, web services, websites, apps, cloud applications, cloud services, back-ends, and/or application programming interface services.

For instance, in some aspects, the SSE system 102 is a provider of machine learning as a service (MLaaS), anomaly detection as a service (ADaaS), software as a service (SaaS), search engine as a service (SEaaS), database as a service (DaaS), storage as a service (STaaS), and/or big data as a service (BDaaS) in a multi-tenancy environment via the Internet, and the SSE system 102 responds to requests 110(1)-(n) submitted to the SSE system 102 by the client devices 104 with the responses 112(1)-(n). Further, in some instances, the SSE system 102 is a multi-tenant environment that provides the client devices 104 with distributed storage and access to software, services, files, and/or data via the one or more network(s) 106. In a multi-tenancy environment, one or more system resources of the SSE system 102 are shared among tenants but individual data associated with each tenant is logically separated. Some examples of a system resource include computing units, bandwidth, data storage, application gateways, software load balancers, memory, field programmable gate arrays (FPGAs), graphics processing units (GPUs), input-output (I/O) throughput, or data/instruction cache.

Some other examples of the SSE system 102 include laptops, desktops, smartphone devices, Internet of Things (IoT) devices, drones, robots, process automation equipment, sensors, control devices, vehicles, transportation equipment, tactile interaction equipment, virtual and augmented reality (VR and AR) devices, industrial machines, and virtual machines. Further, the SSE system 102 may include one or more applications that are configured to interface with the one or more ML models 108(1)-(n). For example, in some aspects, the SSE system 102 includes an application (e.g., the application 508) that generates the requests 110(1)-(n) and receives the responses 112(1)-(n).

As illustrated in FIG. 1, the SSE system 102 includes the one or more ML models 108(1)-(n), one or more token based explanation modules (TBEM) 114(1)-(n), a SSE module 116, and a presentation module 118. In some aspects, the one or more ML 108(1)-(n) are black box ML models configured to generate the inference information 120(1)-(n) based on time series information 122(1)-(n). For instance, in some aspects, the one or more ML models 108(1)-(n) perform time-series forecasting. As used herein, in some aspects, time-series forecasting may refer to a process of using past data to predict future events. Time-series forecasting models are a special class of predictive models used to forecast future events, and differ from other predictive modeling techniques because time-series forecasting models consider the time-based nature of data.

For example, in some aspects, the ML model 108 is configured to receive time series information 122(1) representing temperature values over a period of time, and predict inference information 120(1) representing temperatures at future dates based on the time series information 122(1). As used herein in some aspects, a time series refers to a series of data points indexed (or listed or graphed) in time order. As described herein, in some examples, the SSE system 102 receives a request 110 for inference information 120 based on time series information 122, provides the request 110 to a ML model 108, and transmits a response 112 including the inference information 120 generated by the ML model 108. Some examples of the one or more ML models 108 include deep learning models, convolutional neural networks, deep neural networks, gradient boosting models, ensemble models, etc.

As described herein, in some aspects, the one or more ML models 108 are black models. For example, in some aspects, a ML model is a neural network, which may include multiple hidden layers, multiple neurons per layer, and synapses connecting these neurons together. Further, model weights are applied to data passing through the individual layers of the ML model for processing by the individual neurons. In addition, in some aspects, the SSE system 102 is unaware of one or more internal details of the ML model. For example, even with knowledge of the structure and/or weights of the ML model 108, a system operator may be unable to determine the behavior of the ML model 108 due to the sheer number of weights and/or layers.

In some aspects, the one or more TBEMs 114(1)-(n) are configured to determine token importance information 124(1)-(n) indicating the importance of features (i.e. timestamps) within the time series information 122(1)-(n) to the inference information 120(1)-(n). For example, in some aspects, a TBEM 114 is configured to determine the token importance information 124 indicating that a feature of the time series information has a particular importance value to inference information 120 representing a prediction generated by the ML model 108. Some examples of the one or more TBEMs 114(1)-(n) include the local interpretable model-agnostic explanations (LIME) method or the Shapley additive explanations (SHAP) method. In some aspects, the LIME method employs local surrogate models (linear models) that explain the predictions at local regions. For instance, a LIME method includes sampling points of a local region of interest, weighting the samples by their proximity to the region of interest, and. fitting a weighted, interpretable (i.e., surrogate) model on the dataset with the variations, and interpreting the local surrogate model. As used in herein, in some aspects, a “surrogate model” may refer to a model that is used to explain a more complex model. For example, in some aspects, a surrogate model is created to represent the decision making process of the complex model (i.e., one of the ML models 108) and is a model trained on the input and model predictions, rather than input and targets. In another instance, a SHAP method employs Shapley values to assign the contributions of features of the time series information 122 to the inference information 120. In particular, the SHAP method may include determining the importance of the feature by calculating a base rate, which refers to the model output when using the average of each feature as an input. In addition, for each feature, the average input is replaced with an actual feature value to explain a specific prediction. The difference between the outputs when using the average across all values vs. the actual value for a specific sample is considered the contribution of this specific feature, which explains their impact on the overall result.

In some aspects, the SSE module 116 is configured to determine the spatial saliency information 126. As described herein, in some aspects, the spatial saliency information 126 may refer to global explanation for model-trained time series data for forecasting or anomaly detection. Further, the explanation includes a plurality of feature groups and saliency values for each feature group.

For instance, in some aspects, the SSE module 116 selects a random sample T from X, where X is training data or validation data. Additionally, the SSE module 116 employs the TBEM 114 to determine token importance information 128. In some aspects, the token importance information is a list L(T_{D}ⁱ) including the importance values for each feature of T.

Further, the SSE module 116 generates a list Lₖ (Tⁱ) by selecting a predefined amount k of features from L(T_{D}ⁱ) based on the importance values of the selected features. For example, in some aspects, the SSE module 116 selects k features having the k-highest importance values, e.g., the features having the top ten importance values. In addition, in some aspects, the SSE module 116 generates frequency distribution information for Lₖ (T), and determines spatial grouping information (e.g., quantile information) for the frequency distribution information. For example, in some aspects, the SSE module 116 generates a frequency distribution histogram Hist(L_{K}(T), N_{b}) by binning L_{K}(T) into a predefined number of bins N_{B}, and determines the quantiles of the Hist(L_{K}(T), N_{b}) where N_{Q} is the number of quantiles. In some instances, N_{B} and N_{Q} are hyperparameters that are user defined. In an example, N_{B} equals 150 and N_{Q} equals 5. Further, in some aspects, the SSE module 116 determines the spatial saliency information 126 by calculating the density of feature contribution to a model prediction for each quantile. For example, in some aspects, the SSE module 116 determines the aggregates (e.g., a summation) importance values of the features for each quantile, and divides the aggregated importance of the particular quantile by the width of the quantile, as follows:

$$SSE ( {q}^{i} ) = \frac{{H}^{{q}^{i}}}{R * ( {q}_{h i g h}^{i} - {q}_{l o w}^{i} )}$$

Where R is the total number of datapoints in T, where qᵢ is a tuple denoting quantile or spatial range of time stamps or contributing features, H^{q}^{ⁱ} is the aggregated importance of the features of the quantile, q_{high}ⁱ corresponds to the upper bounds of the quantile, and q_{low}ⁱ. corresponds to the lower bounds of the quantile.

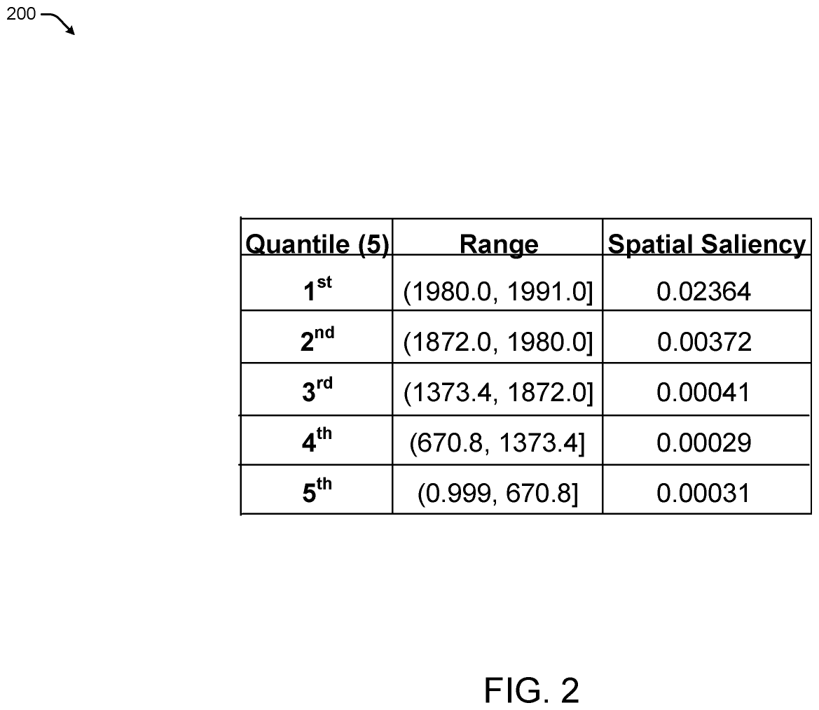

In some aspects, the presentation module 118 generates a graphical user interface (GUI) displaying the spatial saliency information 126. For example, in some aspects, the presentation module 118 generates a graphical user interface including a tabular representation of the spatial saliency information 126 as illustrated in FIG. 2. As another example, in some aspects, the presentation module 118 generates a graphical user interface including a graph representation of the spatial saliency information 126 as illustrated in FIG. 2. Further, in some aspects, the presentation module 118 applies graphical effects to the spatial saliency information 126 within a graphical user interface. For example, in some aspects, the presentation module 118 apply colors, gradients, and overlays to distinguish between the level of saliency of the different spatial groups (e.g., quantiles).

In addition, in some aspects, the presentation module 118 may cause display of the graphical user interface on a display device coupled with the SSE system 102. Additionally, or alternatively, in some aspects, the SSE system 102 receives a request 110 for inference information 120, token importance information 124, and/or spatial saliency information 126 from a client device 104, and the presentation module 118 causes generation of a response 112 including GUI information for displaying the spatial saliency information 126 on a display device coupled with the client device 104.

FIG. 2 illustrates example spatial saliency information in a tabular representation 200, in accordance with some aspects of the present disclosure. As illustrated in FIG. 2, in some aspects, the presentation module 118 generates the tabular representation that presents each spatial group (e.g., quantile), the time stamps associated with the spatial group, and the saliency of the spatial group.

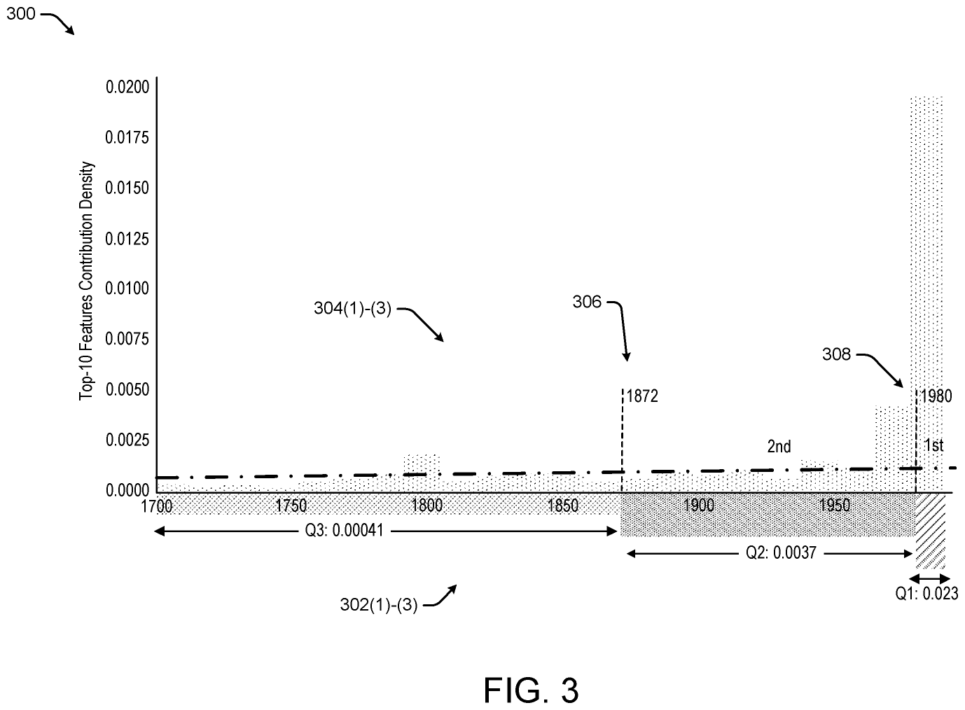

FIG. 3 illustrates example spatial saliency information in a graph representation 300, in accordance with some aspects of the present disclosure. As illustrated in FIG. 3, in some aspects, the presentation module 118 generates the graph representation 300 that presents each of the spatial groups 302(1)-(3) (e.g., quantiles), the time stamps associated with the spatial groups, and the saliency of each of the spatial groups. Further, as illustrated in FIG. 3, in some aspects, the presentation module 118 applies one or more graphical effects to the graph representation 300 to distinguish between the spatial groups. For example, in some aspects, the graph information 304(1) associated with a first spatial group are in a first color, the graph information 304(2) associated with a second spatial group are in a second color, and so forth. Additionally, as illustrated in FIG. 3, the graph illustration 300 may include a first quantile limit 308 and a second quantile limit 306.

### Example Processes

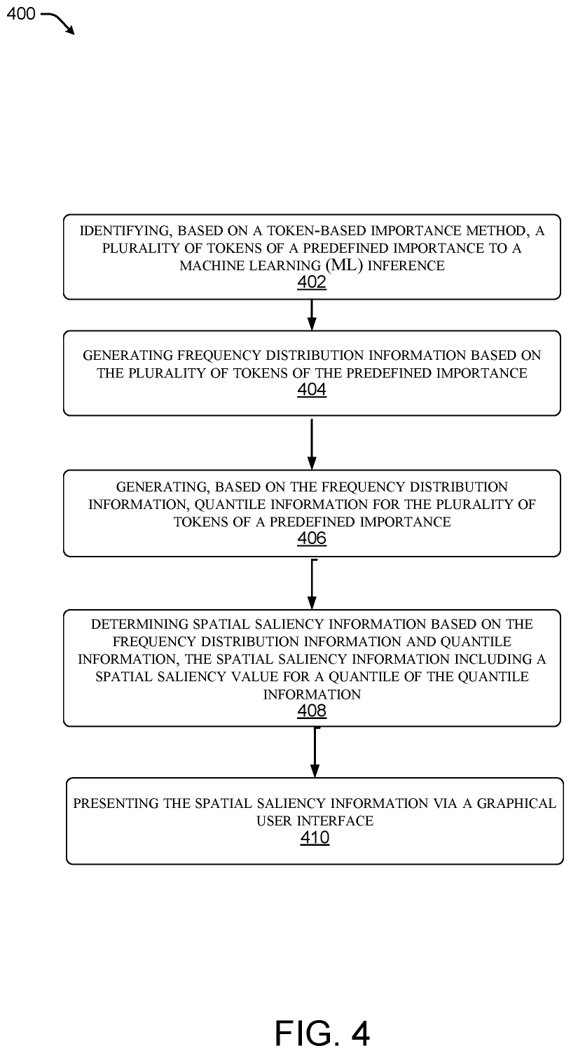

FIG. 4 is a flow diagram illustrating an example method 400 for implementing vendor-agnostic state and configuration collection from network devices, in accordance with some aspects of the present disclosure. The method 400 is performed by one or more components of the SSE system 102, the computing device 500, or any device/component described herein according to the techniques described with reference to the previous figures.

At block 402, the method 400 includes identifying, based on a token-based importance method, a plurality of tokens of a predefined importance to a machine learning (ML) inference. For example, in some aspects, the TBEM 114 determines token importance information 124 indicating that a plurality of feature of the time series information each have a particular importance value to inference information 120 representing a prediction generated by the ML model 108. In some aspects, the TBEM 114 identifies ten tokens having the highest importance value.

Accordingly, the SSE system 102, the computing device 500, and/or the processor 502 executing the TBEM 114 provides means for identifying, based on a token-based importance method, a plurality of tokens of a predefined importance to a machine learning (ML) inference.

At block 404, the method 400 includes generating frequency distribution information based on the plurality of tokens of the predefined importance. For example, in some aspects, the SSE module 116 generates a frequency distribution histogram by binning the selected features of the predefined amount.

Accordingly, the SSE system 102, the computing device 500, and/or the processor 502 executing the verification module 116 provides means for generating frequency distribution information based on the plurality of tokens of the predefined importance.

At block 406, the method 400 includes generating, based on the frequency distribution information, quantile information for the plurality of tokens of a predefined importance. For example, the SSE module 116 determines the quantiles of the frequency distribution histogram determined using by binning the selected features of the predefined amount.

Accordingly, the SSE system 102, the computing device 500, and/or the processor 502 executing the SSE module 116 provides means for generating, based on the frequency distribution information, quantile information for the plurality of tokens of a predefined importance.

At block 408, the method 400 includes calculating spatial saliency information based on the frequency distribution information and quantile information, the spatial saliency information including a spatial saliency value for a quantile of the quantile information. For example, in some aspects, the SSE module 116 determines the spatial saliency information 126 by calculating the density of feature contribution to a model prediction for each quantile. In some aspects, the SSE module 116 determines the aggregated importance of the features for each quantile, and divides the aggregated importance of the particular quantile by the width of the quantile. Spatial saliency for time-series data provides important insights about feature ranges which are contributing most towards the time series forecasting in the given model.

Accordingly, the SSE system 102, the computing device 500, and/or the processor 502 executing the SSE module 116 provides means for calculating spatial saliency information based on the frequency distribution information and quantile information, the spatial saliency information including a spatial saliency value for a quantile of the quantile information.

At block 410, the method 400 includes presenting the spatial saliency information via a graphical user interface. For example, the presentation module 118 generates a graphical user interface (GUI) displaying the spatial saliency information 126, as shown in FIGS. 2-3. In some aspects, the presentation module 118 may cause display of the graphical user interface on a display device coupled with the SSE system 102. Additionally, or alternatively, in some aspects, the SSE system 102 receives a request 110 for inference information 120, token importance information 124, and/or spatial saliency information 126 from a client device 104, and the presentation module 118 causes generation of a response 112 including GUI information for displaying the spatial saliency information 126 on a display device coupled with the client device 104.

Accordingly, the SSE system 102, the computing device 500, and/or the processor 502 executing the presentation module 118 provides means for presenting the spatial saliency information via a graphical user interface.

In some aspects, the techniques described herein relate to a method, further including generating the ML inference based on time series data, wherein the ML inference includes at a predicted value of a time stamp.

In some aspects, the techniques described herein relate to a method, wherein identifying the plurality of tokens of the predefined importance, includes: identifying the plurality of the tokens as a predefined number of tokens having the highest importance according to the token-based importance method.

In some aspects, the techniques described herein relate to a method, wherein token-based importance method includes a local interpretable model-agnostic explanations (LIME) method or a Shapley additive explanations (SHAP) method.

In some aspects, the techniques described herein relate to a method, wherein generating frequency distribution information based on the plurality of tokens of the predefined importance includes generating a frequency distribution histogram based on the plurality of tokens of the predefined importance.

In some aspects, the techniques described herein relate to a method, wherein calculating spatial saliency information based on the frequency distribution information and quantile information includes: determining an aggregated importance of a timestamp range of the quantile of the quantile information; and determining the spatial saliency value based on the aggregated importance and a size of the quantile.

In some aspects, the techniques described herein relate to a method, wherein presenting the spatial saliency information via the graphical user interface includes generating the graphical user interface to include a table presenting the spatial saliency information; and applying, based on the spatial saliency value, within the graphical user interface, one or more graphical effects to table information associated with the quantile of the quantile information.

In some aspects, the techniques described herein relate to a method, wherein presenting the spatial saliency information via the graphical user interface includes: generating the graphical user interface to include a graph representation of time sample information used to generate the ML inference, wherein the graph representation identifies the quantile of the quantile information; and applying, based on the spatial saliency value, within the graphical user interface, one or more graphical effects to graph information associated with the quantile of the quantile information.

In some aspects, the techniques described herein relate to a method, wherein presenting the spatial saliency information via the graphical user interface includes transmitting, to a client device in response to a client request, the spatial saliency information for display via the graphical user interface.

While the operations are described as being implemented by one or more computing devices, in other examples various systems of computing devices may be employed. For instance, a system of multiple devices may be used to perform any of the operations noted above in conjunction with each other.

### Illustrative Computing Device

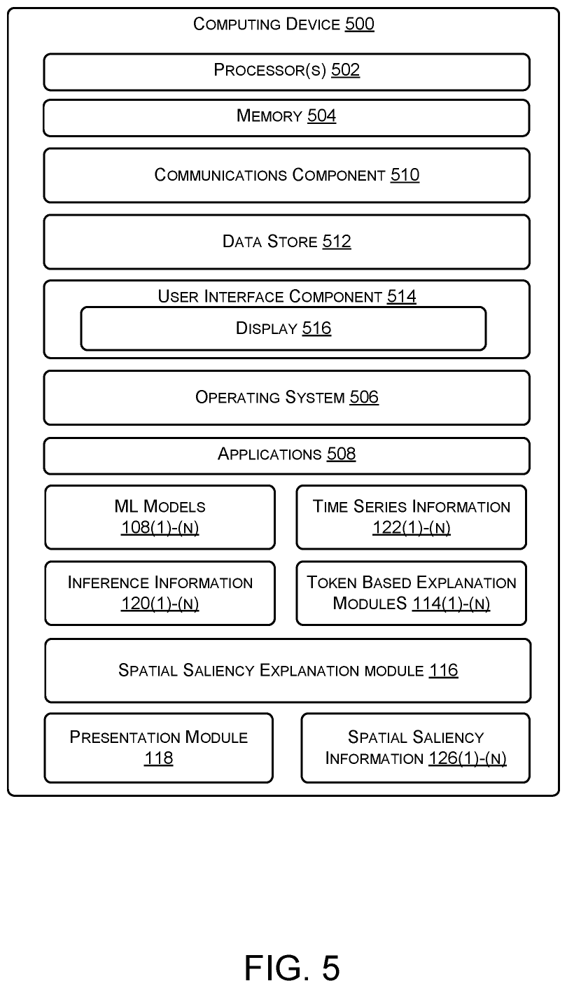

Referring now to FIG. 5, an example of a computing device(s) 500 (e.g., the SSE system 102). In one example, the computing device(s) 500 includes the processor 502 for carrying out processing functions associated with one or more of components and functions described herein. The processor 502 includes a single or multiple set of processors or multi-core processors. Moreover, in some aspects, the processor 502 is implemented as an integrated processing system and/or a distributed processing system. In an example, the processor 502 includes, but is not limited to, any processor specially programmed as described herein, including a controller, microcontroller, a computer processing unit (CPU), a graphics processing unit (GPU), an application specific integrated circuit (ASIC), a field programmable gate array (FPGA), a system on chip (SoC), or other programmable logic or state machine. Further, the processor 502 may include other processing components such as one or more arithmetic logic units (ALUs), registers, or control units.

In an example, the computing device 500 also includes memory 504 for storing instructions executable by the processor 502 for carrying out the functions described herein. The memory 504 may be configured for storing data and/or computer-executable instructions defining and/or associated with the one or more ML models 108(1)-(n), the TBEM modules 114(1)-(n), the SSE module 116, and the presentation module 118, the time series information 122(1)-(n), the inference information 120(1)-(n), the token importance information 124(1)-(n), and the spatial saliency information 126(1)-(n), and the processor 502 may execute the one or more ML models 108(1)-(n), the TBEM modules 114(1)-(n), the SSE module 116, and the presentation module 118. An example of memory 504 may include, but is not limited to, a type of memory usable by a computer, such as random access memory (RAM), read only memory (ROM, optical discs, volatile memory, non-volatile memory, and any combination thereof. In an example, the memory 504 may store local versions of applications being executed by processor 502.

The example computing device 500 includes a communications component 510 that provides for establishing and maintaining communications with one or more other devices utilizing hardware, software, and services as described herein. The communications component 510 may carry communications between components on the computing device 500, as well as between the computing device 500 and external devices, such as devices located across a communications network and/or devices serially or locally connected to the computing device 500. For example, the communications component 510 may include one or more buses, and may further include transmit chain components and receive chain components associated with a transmitter and receiver, respectively, operable for interfacing with external devices.

The example computing device 500 includes a datastore 512, which may be any suitable combination of hardware and/or software, that provides for mass storage of information, databases, and programs employed in connection with implementations described herein. For example, the datastore 512 may be a data repository for the operating system 506 and/or the applications 508.

The example computing device 500 includes a user interface component 514 operable to receive inputs from a user of the computing device 500 and further operable to generate outputs for presentation to the user (e.g., a presentation of a GUI). The user interface component 514 may include one or more input devices, including but not limited to a keyboard, a number pad, a mouse, a touch-sensitive display (e.g., display 516), a digitizer, a navigation key, a function key, a microphone, a voice recognition component, any other mechanism capable of receiving an input from a user, or any combination thereof. Further, the user interface component 514 may include one or more output devices, including but not limited to a display (e.g., display 516), a speaker, a haptic feedback mechanism, a printer, any other mechanism capable of presenting an output to a user, or any combination thereof.

In an implementation, the user interface component 514 may transmit and/or receive messages corresponding to the operation of the operating system 506 and/or the applications 508. In addition, the processor 502 executes the operating system 506 and/or the applications 508, and the memory 504 or the datastore 512 may store them.

Further, one or more of the subcomponents of the one or more ML models 108(1)-(n), the TBEM modules 114(1)-(n), the SSE module 116, and the presentation module 118 may be implemented in one or more of the processor 502, the applications 508, the operating system 506, and/or the user interface component 514 such that the subcomponents of the one or more ML models 108(1)-(n), the TBEM modules 114(1)-(n), the SSE module 116, and the presentation module 118 are spread out between the components/subcomponents of the computing device 500.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Non-transitory computer-readable media excludes transitory signals. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
identifying, based on a token-based importance method, a plurality of tokens of a predefined importance to a machine learning (ML) inference;
generating frequency distribution information based on the plurality of tokens of the predefined importance;
generating, based on the frequency distribution information, quantile information for the plurality of tokens of a predefined importance;
calculating spatial saliency information based on the frequency distribution information and quantile information, the spatial saliency information including a spatial saliency value for a quantile of the quantile information; and
presenting the spatial saliency information via a graphical user interface.

2. The method of claim 1, further comprising generating the ML inference based on time series data, wherein the ML inference includes at a predicted value of a time stamp.

3. The method of claim 1, wherein identifying the plurality of tokens of the predefined importance, comprises:
identifying the plurality of the tokens as a predefined number of tokens having the highest importance values according to the token-based importance method.

4. The method of claim 1, wherein token-based importance method includes a local interpretable model-agnostic explanations (LIME) method or a Shapley additive explanations (SHAP) method.

5. The method of claim 1, wherein generating frequency distribution information based on the plurality of tokens of the predefined importance comprises generating a frequency distribution histogram based on the plurality of tokens of the predefined importance.

6. The method of claim 1, wherein calculating spatial saliency information based on the frequency distribution information and quantile information comprises:
determining an aggregated importance of a timestamp range of the quantile of the quantile information; and
determine the spatial saliency value based on the aggregated importance and a size of the quantile.

7. The method of claim 1, wherein presenting the spatial saliency information via the graphical user interface comprises
generating the graphical user interface to include a table presenting the spatial saliency information; and
applying, based on the spatial saliency value, within the graphical user interface, one or more graphical effects to table information associated with the quantile of the quantile information.

8. The method of claim 1, wherein presenting the spatial saliency information via the graphical user interface comprises:
generating the graphical user interface to include a graph representation of time sample information used to generate the ML inference, wherein the graph representation identifies the quantile of the quantile information; and
applying, based on the spatial saliency value, within the graphical user interface, one or more graphical effects to graph information associated with the quantile of the quantile information.

9. The method of claim 1, wherein presenting the spatial saliency information via the graphical user interface comprises transmitting, to a client device in response to a client request, the spatial saliency information for display via the graphical user interface.

10. A system comprising:
a memory storing instructions thereon; and
at least one processor coupled with the memory and configured by the instructions to:
identify, based on a token-based importance method, a plurality of tokens of a predefined importance to a machine learning (ML) inference;
generate frequency distribution information based on the plurality of tokens of the predefined importance;
generate, based on the frequency distribution information, quantile information for the plurality of tokens of a predefined importance;
determine spatial saliency information based on the frequency distribution information and quantile information, the spatial saliency information including a spatial saliency value for a quantile of the quantile information; and
present the spatial saliency information via a graphical user interface.

11. The system of claim 10, wherein the at least one processor is further configured by the instructions to:
generate the ML inference based on time series data, wherein the ML inference includes at a predicted value of a time stamp.

12. The system of claim 10, wherein identifying the plurality of tokens of the predefined importance, the at least one processor is further configured by the instructions to identify the plurality of the tokens as a predefined amount of tokens having the highest importance values according to the token-based importance method.

13. The system of claim 10, wherein token-based importance method includes a local interpretable model-agnostic explanations (LIME) method or a Shapley additive explanations (SHAP) method.

14. The system of claim 10, wherein to determine spatial saliency information based on the frequency distribution information and quantile information, the at least one processor is further configured by the instructions to:
determine an aggregated importance of a timestamp range of the quantile of the quantile information; and
determine the spatial saliency value based on the aggregated importance and a size of the quantile.

15. A non-transitory computer-readable device having instructions thereon that, when executed by at least one computing device, cause the at least one computing device to perform operations comprising:
identifying, based on a token-based importance method, a plurality of tokens of a predefined importance to a machine learning (ML) inference;
generating frequency distribution information based on the plurality of tokens of the predefined importance;
generating, based on the frequency distribution information, quantile information for the plurality of tokens of a predefined importance;
calculating spatial saliency information based on the frequency distribution information and quantile information, the spatial saliency information including a spatial saliency value for a quantile of the quantile information; and
presenting the spatial saliency information via a graphical user interface.

16. The non-transitory computer-readable device of claim 15, wherein the operations comprise:
generating the NIL inference based on time series data, wherein the NIL inference includes at a predicted value of a time stamp.

17. The non-transitory computer-readable device of claim 15, herein identifying the plurality of tokens of the predefined importance, comprises:
identifying the plurality of the tokens as a predefined number of tokens having the highest importance values according to the token-based importance method.

18. The non-transitory computer-readable device of claim 15, wherein token-based importance method includes a local interpretable model-agnostic explanations (LIME) method or a Shapley additive explanations (SHAP) method.

19. The non-transitory computer-readable device of claim 15, wherein generating frequency distribution information based on the plurality of tokens of the predefined importance comprises generating a frequency distribution histogram based on the plurality of tokens of the predefined importance.

20. The non-transitory computer-readable device of claim 15, wherein calculating spatial saliency information based on the frequency distribution information and quantile information comprises:
determining an aggregated importance of a timestamp range of the quantile of the quantile information; and
determining the spatial saliency value based on the aggregated importance and a size of the quantile.
